(19) United States
(12) Patent Application Publication
(10) Pub. No.: US 2023/0032083 A1
(43) Pub. Date: Feb. 2, 2023

(54) SELF CONTROL PROBLEM HANDLER

(71) Applicant: INTUIT INC., Mountain View, CA (US)

(72) Inventors: Yair HORESH, Tel Aviv (IL); Daniel Ben DAVID, Tel Aviv (IL)

(73) Assignee: INTUIT INC., Mountain View, CA (US)

(21) Appl. No.: 17/387,783

(22) Filed: Jul. 28, 2021

(51) Int. Cl. G06Q 40/00; G06K 9/62; G06N 5/04; G06N 20/20

(52) U.S. Cl. CPC G06Q 40/125; G06K 9/6218; G06N 5/04; G06N 20/20

(57) ABSTRACT

A method of determining whether a user has a self-control problem. A computing system receives, from a plurality of financial institutions associated with a target user, a plurality of transactions associated with the target user. The computing system groups the plurality of transactions into a category or subcategory based on transaction data associated with each respective transaction. The computing system determines, based on the plurality of transactions, that the target user has a self-control problem. The computing system, responsive to determining that the target user has the self-control problem, generates an alert or recommendation to the target user. The alert or recommendation notifies the target user of the self-control problem.

### BACKGROUND

Self-control problems have been well documented over the past several decades. Time inconsistency and the lack of self-discipline by decision makers have numerous implications in many aspects of life. From smokers who self-report their unmet desire to stop smoking for many years to students attempting to achieve better grades in school. In the financial arena, those individuals that receive lower wages typically tend to attain more debt and fail to build their savings, particularly long term savings, such as retirement. There is a need and desire, therefore, to determine if an individual has a self-control problem and proactively address the problem.

### BRIEF DESCRIPTION OF THE FIGURES

FIG. 1 shows an example computing environment, according to various embodiments of the present disclosure.

FIG. 2 is a block diagram illustrating a back-end computing system, according various embodiments of the present disclosure.

FIG. 3 is a chart that illustrates self-control problem characteristics from a regression analysis according to example embodiments.

FIG. 4 is a flow diagram illustrating a method of addressing self-control problems, according to example embodiments.

FIG. 5 is a block diagram illustrating an example computing device, according to various embodiments of the present disclosure.

### DETAILED DESCRIPTION OF SEVERAL EMBODIMENTS

One or more techniques provided herein are generally directed to a method of determining whether a user has a self-control problem. For example, one or more techniques provided herein may analyze each payroll period for a user over an extended time to determine whether the user exhibits a “self-control problem.” A self-control problem may be present based when the system analyzes key metrics in a user's transaction history to determine that the user more frequently transacts at the beginning of a payroll period (e.g., immediately after receiving a paycheck) compared to the end of the payroll period (e.g., right before the next paycheck). Once identified, the present system may take various actions to assist the user in managing their self-control problem.

In one or more embodiments, a computing system receives, from a plurality of financial institutions associated with a target user, a plurality of transactions associated with the target user. The computing system groups the plurality of transactions into a category or subcategory based on transaction data associated with each respective transaction. The computing system determines, based on the plurality of transactions, that the target user has a self-control problem.

In one or more embodiments, to determine that the target user has a self-control problem, the computing system identifies a plurality of payroll periods, each payroll period being associated with a paycheck. For each payroll period, the computing system identifies a first subset of transactions that occur at a beginning of a respective payroll period and a second subset of transactions that occur at an end of the respective payroll period. For each payroll period, the computing system filters the first subset of transactions and the second subset of transactions to include discretionary expenses. For each payroll period, the computing system sums the discretionary expenses in the first subset of transactions to generate a first sum, sums the discretionary expenses in the second subset of transactions to generate a second sum and applies a parametric test to the first sum and the second sum for each payroll period to determine whether the target user has the self-control problem. The computing system, responsive to determining that the target user has the self-control problem, generates an alert or recommendation to the target user. The alert or recommendation notifies the target user of the self-control problem.

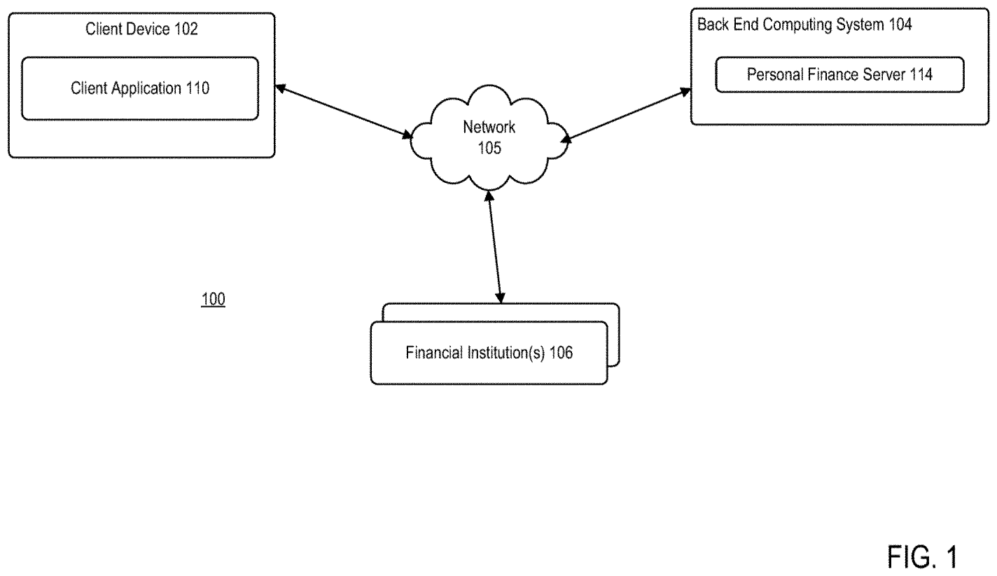

FIG. 1 shows an example computing environment 100, according to embodiments of the present disclosure. Computing environment 100 may include one or more client devices 102 and a back-end computing system 104. Client devices 102 and back-end computing system 104 may be configured to communicate through network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

For example, network 105 may be the Internet, a private data network, virtual private network using a public network and/or other suitable connection(s) that enables components in computing environment 100 to send and receive information between the components of computing environment 100.

In some embodiments, communication between the elements may be facilitated by one or more application programming interfaces (APIs). APIs of back-end computing system 104 may be proprietary and/or may be examples available to those of ordinary skill in the art such as Amazon® Web Services (AWS) APIs or the like.

Client device 102 may be operated by a user. Client device 102 may be representative of a mobile device, a tablet, a desktop computer, or any computing system having the capabilities described herein. Client device 102 may include at least client application 110. Application 110 may be representative a web browser or a stand-alone application associated with back-end computing system 104. A user of client device 102 will utilize application 110 to access functionality associated with back-end computing system 104. In some embodiments, client device 102 may communicate over network 105 to request content, for example, from personal finance server 114. In some embodiments, client device 102 may utilize application 110 to access a personal finance account associated with personal finance server 114. In some embodiments, personal finance server 114 may be representative of a server associated with Mint®, a personal finance website and application commercially available from Intuit®. Via application 110, a user may be provided with a page or portal that aggregates all of the user's financial accounts in a single location.

Back-end computing system 104 is configured to communicate with one or more client devices 102. As shown, back-end computing system 104 includes a personal finance server 114. Personal finance server 114 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather as a result of the instructions.

In one or more embodiments, personal finance server 114 may be configured to manage financial accounts for various users having an account with back-end computing system 104. For example, personal finance server 114 may be configured to aggregate financial information from a plurality of financial accounts, display the financial information to the user, and/or generate alerts or insights based on the financial information associated with the plurality of financial accounts. In this manner, a user may be provided with an overview of their financial situation in a single location. In some embodiments, personal finance server 114 may be configured to host various webpages associated with the financial service. In some embodiments, personal finance server 114 may be configured to host content associated with a desktop or mobile application associated with the financial service. In this manner, the user may access their account via a browser or native application.

Financial institutions 106 may be representative of a plurality of financial institutions with which the user may interact. In some embodiments, financial institutions 106 may be representative of one or more of central banks, retail banks, credit unions, investment banks, brokerage firms, insurance firms, and the like. The user may have a plurality of individual accounts with a plurality of financial institutions 106. Financial institutions 106 may synchronize the financial data in a user's individual account with the user's account with back-end computing system 104. For example, financial institutions 106 may stream or provide back-end computing system 104 with financial data related to the user's individual account via one or more APIs associated with back-end computing system 104. In this manner, personal finance server 114 may aggregate the user's individual account information across a plurality of financial institutions 106 into a single location.

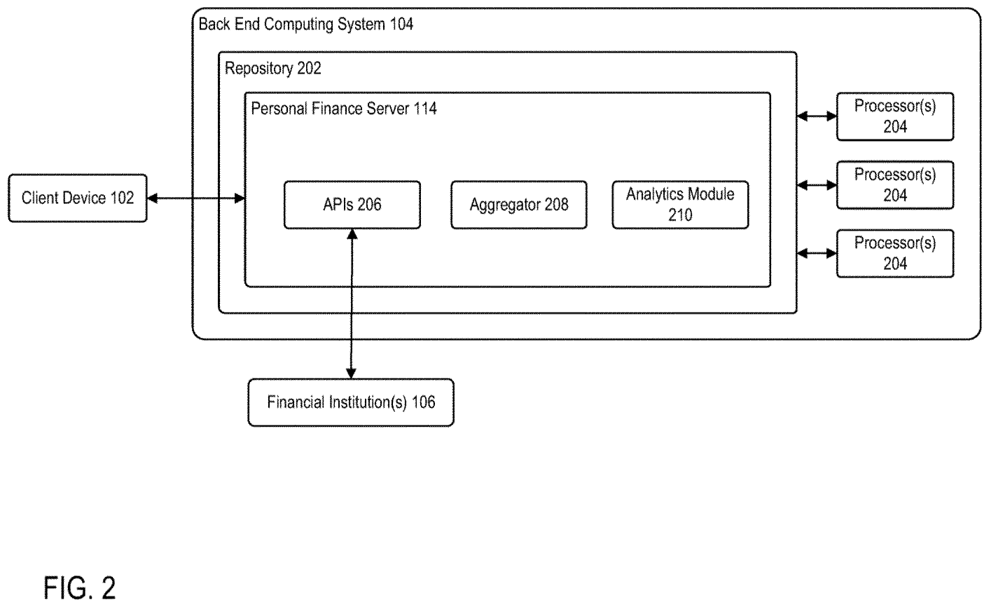

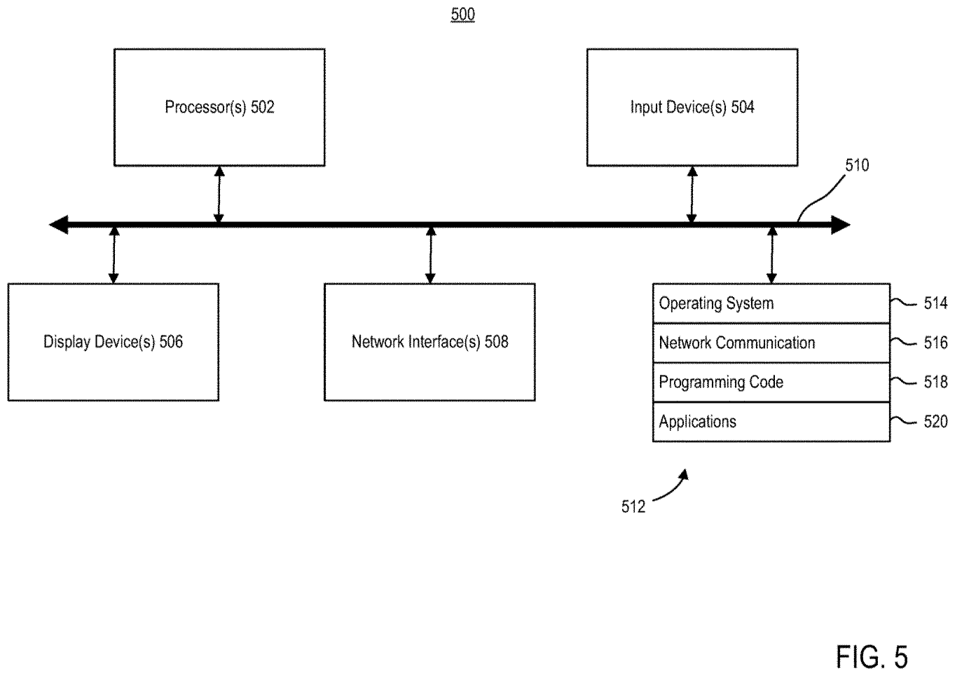

FIG. 2 is a block diagram illustrating back-end computing system 104, according to one or more embodiments disclosed herein. As shown in the illustrated example, back-end computing system 104 includes a repository 202 and one or more computer processors 204. In some embodiments, back-end computing system 104 may take the form of the computing device 500 described in FIG. 5 and the accompanying description below. In one or more embodiments, one or more computer processors 204 may take the form of computer processor(s) 502 described in FIG. 5 and the accompanying description below.

In some embodiments, repository 202 may be any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes personal finance server 114.

Personal finance server 114 is configured to aggregate a plurality of individual financial accounts of the user with a plurality of financial institutions 106. As shown, personal finance server 114 includes one or more application programming interfaces (APIs) 206, an aggregator 208, and an analytics module 210. Each of aggregator 208 and analytics module 210 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather as a result of the instructions.

APIs 206 are configured to allow one or more financial institutions 106 to communicate with back-end computing system 104. For example, via one or more APIs 206, a financial institution 106 may provide a user's account data to personal finance server 114. Using a specific example, financial institution 106 may provide personal finance server 114 with transaction data for each transaction logged by financial institution 106. In some embodiment, each transaction may include one or more of a transaction type (e.g., credit vs. debit), a transaction amount, a transaction date, a party with which the user transacted (e.g., a merchant identifier or merchant category code), and the like. In this manner, personal finance server 114 may be provided with a more complete picture of each transaction.

Aggregator 208 is configured to aggregate transactions across a plurality of financial institutions 106. In some embodiments, aggregator 208 may be configured to aggregate transaction based on account type. For example, aggregator 208 may provide the user with a total amount of cash, credit card debt, loan debt, investment capital, and the like. In some embodiments, aggregator 208 may include one or more rules or logic for grouping transactions. For example, based on the merchant category code, aggregator 208 may categorize each transaction into one or more predefined categories. Exemplary categories may include, but are not limited to, income, entertainment, education, shopping, personal care, health and fitness, food and fining, gifts and donations, investments, bills and utilities, auto and transport, travel, fees and charges, business services, taxes, miscellaneous, and the like.

In some embodiments, each of the aforementioned categories may include one or more subcategories. For example, an income category may include one or more subcategories such as, but not limited to, paycheck, investment, returned purchase, bonus, interest income, reimbursement, rental income, and the like.

An entertainment category may include one or more subcategories such as, but not limited to, arts, music, movies and DVDs, newspaper and magazines, and the like.

An education category may include one or more subcategories such as, but not limited to, tuition, student loan, books and supplies, and the like.

A shopping category may include one or more subcategories, such as, but not limited to, clothing, books, electronics and software, hobbies, sporting goods, and the like.

A personal care category may include one or more subcategories, such as, but not limited to, laundry, hair, spa and massage, and the like.

A health and fitness category may include one or more subcategories, such as, but not limited to, dentist, doctor, eye care, pharmacy, health insurance, gym, sports, and the like.

A kids category may include one or more subcategories, such as, but not limited to, activities, allowance, baby supplies, babysitter and daycare, child support, toys, and the like.

A food and dining category may include one or more subcategories, such as, but not limited to, groceries, coffee shops, fast food, restaurants, alcohol, and the like.

A gifts and donations category may include one or more subcategories, such as, but not limited to gifts, charity, and the like.

An investments category may include one or more subcategories, such as, but not limited to deposit, withdrawal, dividends and capital gains, buy, sell, and the like.

A bills and utilities category may include one or more subcategories, such as, but not limited to television, home phone, internet, mobile phone, utilities, and the like.

An auto and transport category may include one or more subcategories, such as, but not limited to gas and fuel, parking, service and auto parts, auto payment, auto insurance, and the like.

A travel category may include one or more subcategories, such as, but not limited to air travel, hotel, rental car and taxi, vacation, and the like.

A fees and charges category may include one or more subcategories, such as, but not limited to service fee, late fee, finance charge, ATM fee, bank fee, commissions, and the like.

A business services category may include one or more subcategories, such as, but not limited to advertising, office supplies, printing, shipping, legal, and the like.

A taxes category may include one or more subcategories, such as, but not limited to federal tax, state tax, local tax, sales tax, property tax, and the like.

A miscellaneous category may include one or more subcategories, such as, but not limited to cash and ATM, check, and the like.

Accordingly, in this manner, aggregator 208 provides a user with a more complete overview of their spending habits by categorizing transactions into one or more categories and/or subcategories.

Analytics module 210 is configured to analyze the user's transactions to determine whether the user has a self-control problem. A self-control problem may refer to a user's tendency to focus more on short-term spending and fail to act in pursuing long-term goals due to lack of self-discipline. The transactions that trigger self-control problems may be categorized, broadly, as discretionary expenses. Exemplary discretionary expenses may include those expenses that fall under the following categories and/or sub-categories: restaurants, alcohol, spa and massage, clothing, books, electronics, hobbies, sporting goods, and the like.

To determine whether a user has a self-control problem, analytics module 210 identifies, within the user's transaction history, payroll periods and paycheck days, i.e., those days that the user received a paycheck from their employer. For each payroll period, analytics module 210 may sum and count discretionary expenses during a window immediately after the user's paycheck day and immediately before the user's next paycheck day. For example, if analytics module 210 determines that the user receives a first paycheck on the July 2 and a second paycheck on July 16, analytics module 210 may identify those transactions that fall under discretionary spending in a window of five days after the first paycheck and five days before the second paycheck. In this manner, analytics module 210 may determine whether the user can exhibit self-control following receipt of a paycheck by comparing discretionary spending at the beginning of a payroll period and the end of the payroll period. Analytics module 210 may not perform such analysis in a vacuum for a given payroll period. Instead, analytics module 210 may analyze the beginning and end of each payroll period across a length of time, such as a year or more. Using this subset of transactions, for each payroll period, analytics module 210 may sum the discretionary transactions at the beginning of the payroll period and the end of the payroll period. In this manner, analytics module 210 may have two values per payroll period.

Using the two values per payroll period, analytics module 210 applies a Wilcoxon parametric test (e.g., Wilcoxon signed-rank test) to the differences between the two values. For example, assume that the user has three payroll periods: p₁, p₂, p₃. Each payroll period may include four values: a beginning discretionary expenses value, aᵢ; an ending discretionary expenses value, bᵢ; a beginning discretionary expenses count cᵢ; and an ending discretionary expenses count, d₁. In this manner, p₁={a₁, b₁, c₁, d₁}, p₂={a₂, b₂, c₂, d₂}, p₃={a₃, b₃, c₃, d₃} or more generally, pᵢ={aᵢ, bᵢ, cᵢ, dᵢ}, where i∈[1,n] and n corresponds to a payroll period.

Based on the output from the Wilcoxon parametric test, analytics module 210 assigns a self-control problem ranking to each user. For example, analytics module 210 may assign a value of 0 to a user if there is no significant difference in their discretionary spending habits; analytics module 210 may uniformly distribute a ranking to those users with greater than a threshold amount of confidence (e.g., 90% or greater) that they exhibit self-control problems. For example, the ranking may be uniformly distributed between 0 and 1.

In this manner, analytics module 210 may not only identify those users that may have self-control problems and those that do not have self-control problems, but also may rank those users that have self-control problems based on a degree to which the self-control problem exists.

In some embodiments, analytics module 210 may not solely rely on transaction data to identify self-control problems. For example, analytics module 210 may prompt user with various questionnaires to receive a second indication of user self-control problems. In some embodiments, users may be prompted with the questionnaire upon gaining access to personal finance software via application 110 executing on client device 102.

Additionally, in some embodiments, analytics module 210 derives or generates additional features for evaluation with the transaction data. For example, analytics module 210 may derive or generate additional features, for each user, that may be used to find correlations with self-control problems. Exemplary additional features may include, but are not limited to, level of cash liquidity, debt, debt-income-savings ratio, commitment devices (e.g., goals defined in personal financial software, life insurance, elective insurance, etc.), special sale days exploitations (e.g., does the use exploit sales, such as Black Friday, President's Day, etc.), cost of living expenses, loan information, religion donations, gym equipment, and the like.

Using the questionnaires and/or additional features, analytics module 210 identifies correlations between the self-control problem rankings and relevant variable that may be associated with a self-control problem. For example, analytics module 210 may utilize a regression algorithm (e.g., ordinary least squares regression) to identify correlations between the additional features and the self-control problem rankings.

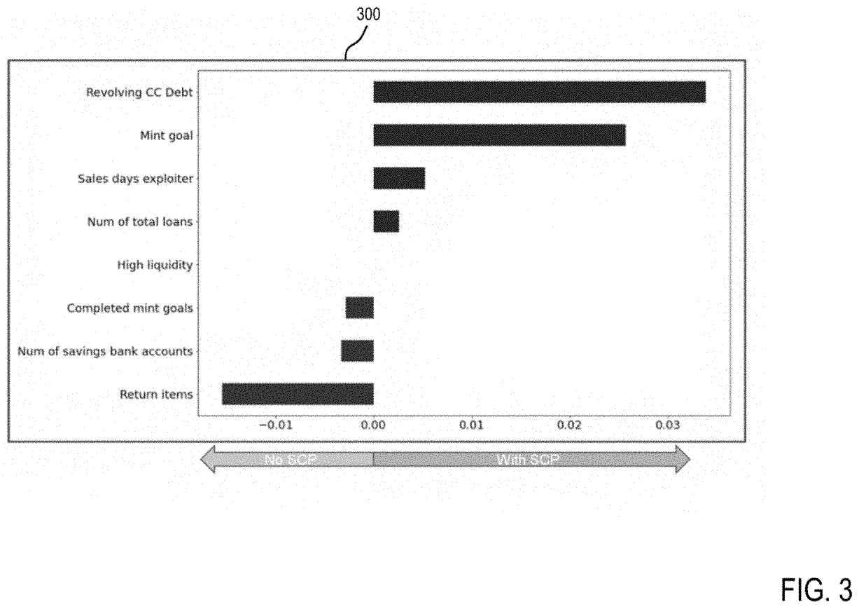

FIG. 3 is a chart 300 that illustrates results from the regression analysis according to example embodiments. As shown, the y-axis includes exemplary variables, such as those additional features provided above, that may be generated by analytics module 210. For example, the exemplary variables may include, but are not limited to, revolving credit card (CC) debt, Mint goal, sales day exploiter, number of total loans, high liquidity, completed mint goals, number of savings bank accounts, return items, and the like The x-axis may denote the self-control problem rankings. Values to the right of the 0.0 may correspond to those users that have a self-control problem; values to the left of the 0.0 may correspond to those users that do not have a self-control problem. As shown in chart 300, those users that have self-control problems typically have revolving credit card debt, have defined goals in their personal finance software, exploit sales days, and have a greater number of loans. In comparison, those users that do not have self-control problems typically complete their defined goals, have a savings account, and return items more frequently.

Referring back to FIG. 2, based on the self-control problem rankings, analytics module 210 generates various insights to users exhibiting self-control problems to assist them in addressing or overcoming their self-control problems. To generate these insights, analytics module 210 may utilize a clustering algorithm that is configured to analyze various attributes and each user in the userbase to cluster similar users. For example, analytics module 210 may analyze user-level information such as, but not limited to, one or more of income, age, gender, marital status, zip code, family size, and the like for users with self-control problems and users without self-control problems. Based on this analysis, clustering algorithm may identify a plurality of clusters of similar users.

Analytics module 210 analyzes each cluster to generate insights or recommendations to provide to users that exhibit self-control problems. For example, analytics module 210 may analyze each cluster of users. As provided above, each cluster of users may include users that exhibit self-control problems and users that do not exhibit self-control problems; each user in each cluster, however, is similar based on the various demographic information. Analytics module 210 may analyze various financial metrics associated with the users that do not exhibit self-control problems. For example, analytics module 210 may analyze one or more of debt indicators (e.g., credit card debt, student loan debt, mortgage, etc.), savings indicators (e.g., available liquidity, 401Ks, etc.), exploitation of special sale days, and the like to learn those features that are more frequently attributed to users that do not exhibit self-control problems.

Based on this analysis, analytics module 210 generates recommendations or insights to users exhibiting self-control problems. For example, analytics module 210 may provide users with a push notification that reads: “Users with your income level that do not exhibit self-control problems typically move at least 10% of their paycheck to a savings account.” Another exemplary insight may be: “Consider contributing 2% of your paychecks to a 401k to build a retirement account.” Yet another exemplary insight may be: “Paying $100 extra on every loan payment could help pay off your loan a year earlier than expected.” Another exemplary insight may be: “Don't lose $X to interest and fees on your credit cards. It seems that you paid more than your peers on clothing and restaurants this quarter. Do you want us to help you monitor these expenses and reduce your cc debt?”

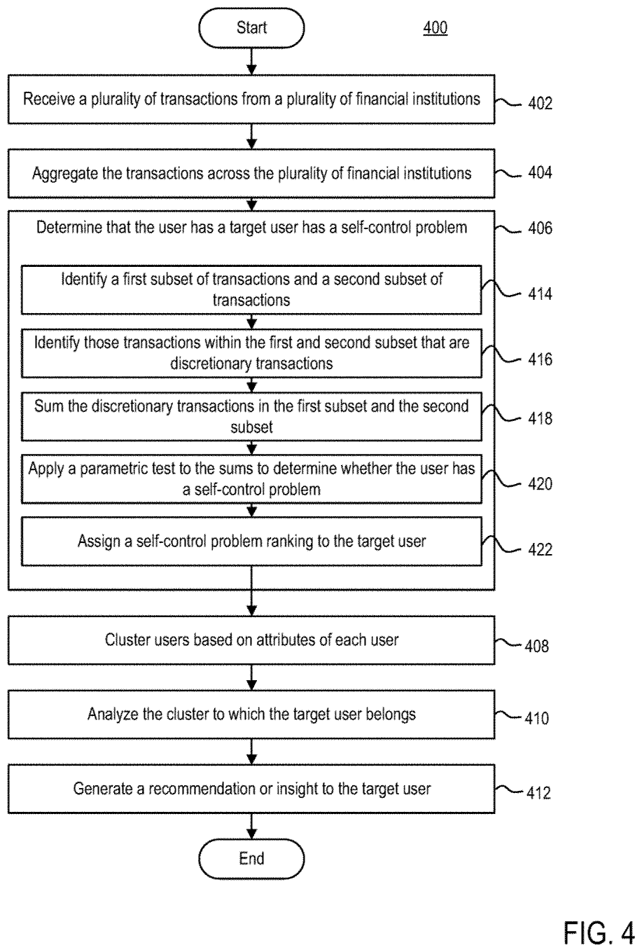

FIG. 4 is a flow diagram illustrating a method 400 of determining and addressing self-control problems, according to example embodiments. Method 400 may begin at step 402.

At step 402, back-end computing system 104 receives a plurality of transactions from a plurality of financial institutions 106 associated with the user. For example, back-end computing system 104 may receive transaction data for each transaction logged by a respective financial institution 106. In some embodiment, each transaction may include metadata associated therewith. Exemplary metadata may include, but is not limited to, one or mor of a transaction type (e.g., credit vs. debit), a transaction amount, a transaction date, a party with which the user transacted (e.g., a merchant identifier or merchant category code), and the like. In some embodiments, back-end computing system 104 may receive the transaction data via one or more APIs 206.

At step 404, back-end computing system 104 aggregates transactions across a plurality of financial institutions 106. In some embodiments, aggregator 208 may aggregate transactions based on account type. For example, aggregator 208 may provide the user with a total amount of cash, credit card debt, loan debt, investment capital, and the like. In some embodiments, aggregator 208 may include one or more rules or logic for grouping transactions. For example, based on the merchant category code, aggregator 208 may categorize each transaction into one or more predefined categories and/or sub-categories.

At step 406, back-end computing system 104 determines that the user has a self-control problem. A self-control problem may refer to a user's tendency to focus more on short-term spending and fail to act in pursuing long-term goals due to lack of self-discipline. The transactions that trigger self-control problems may be categorized, broadly, as discretionary expenses. Step 406 may include a plurality of sub-steps 414-422.

At sub-step 414, analytics module 210 may identify a first subset of transactions that occur directly after the user receives a paycheck and a second subset of transactions that occur right before the user receives a following paycheck. In other words, analytics module 210 may identify those transactions that occur at the very beginning of and the very end of a payroll period.

At sub-step 416, analytics module 210 may identify those transactions within the first subset of transactions and the second subset of transactions that are discretionary expenses. For example, analytics module 210 may leverage the categories and/or sub-categories associated with each transaction to identify the subset of transactions that are discretionary.

At sub-step 418, analytics module 210 may sum the discretionary transactions in the first subset of transactions and the discretionary transactions in the second subset of transactions. Analytics module 210 may further sum the number of discretionary transactions in the first subset of transactions and the number of discretionary transactions in the second subset of transactions.

At sub-step 420, analytics module 210 may apply a Wilcoxon parametric test to determine whether the target user has a self-control problem. For example, using the two values per payroll period, analytics module 210 may apply a Wilcoxon parametric test (e.g., Wilcoxon signed-rank test) to the differences between the two values. A user may have a self-control problem when there is a threshold level of confidence (e.g., 90%) that the user has a self-control problem. A self-control problem may be evident when a user spends substantially more on discretionary expenses at the beginning of the payroll period.

At sub-step 422, analytics module 210 assigns a self-control problem ranking to the target. For example, analytics module 210 may assign a value of 0 to a user if there is no significant difference in their discretionary spending habits; analytics module 210 may uniformly distribute a ranking to the target user with greater than a threshold amount of confidence (e.g., 90% or greater) that they exhibit self-control problems.

At step 408, back-end computing system 104 clusters users (both user that have a self-control problem and users that do not have a self-control problem) based on attributes of each user. For example, analytics module 210 may utilize a clustering algorithm that is configured to analyze various attributes and each user in the userbase to cluster similar users. To do so, analytics module 210 may analyze user-level information such as, but not limited to, one or more of income, age, gender, marital status, zip code, family size, and the like for users with self-control problems and users without self-control problems. Based on this analysis, clustering algorithm may identify a plurality of clusters of similar users, include the target user.

At step 410, back-end computing system 104 analyzes the cluster to which the target user is assigned to generate insights or recommendations to help address the user's self-control problem. Analytics module 210 may analyze various financial metrics associated with other users in the cluster that do not exhibit self-control problems. For example, analytics module 210 may analyze one or more of debt indicators (e.g., credit card debt, student loan debt, mortgage, etc.), savings indicators (e.g., available liquidity, 401Ks, etc.), exploitation of special sale days, and the like to learn those features that are more frequently attributed to users that do not exhibit self-control problems that are in the same cluster as the target users.

At step 412, back-end computing system 104 generates recommendations or insights to the target user. The recommendation or insight may be generated based on the analysis of financial habits of users in the same cluster that do not exhibit self-control problems.

FIG. 5 shows an example computing device according to an embodiment of the present disclosure. For example, computing device 500 may function as back-end computing system 104. The illustrated computing device 500 includes a personal finance server 114 that executes the processing operations described above or a portion or combination thereof in some embodiments. The computing device 500 may be implemented on any electronic device that runs software applications derived from compiled instructions, including without limitation personal computers, servers, smart phones, media players, electronic tablets, game consoles, email devices, etc. In some implementations, the computing device 500 may include one or more processors 502, one or more input devices 504, one or more display devices 506, one or more network interfaces 508, and one or more computer-readable mediums 512. Each of these components may be coupled by bus 510, and in some embodiments, these components may be distributed among multiple physical locations and coupled by a network.

Display device(s) 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device(s) 504 may be any known input device technology, including but not limited to a keyboard (including a virtual keyboard), mouse, track ball, camera, and touch-sensitive pad or display. Bus 510 may be any known internal or external bus technology, including but not limited to ISA, EISA, PCI, PCI Express, USB, Serial ATA or FireWire. Computer-readable medium 512 may be any non-transitory medium that participates in providing instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 may include various instructions for implementing an operating system 514 (e.g., Mac OS®, Windows®, Linux). The operating system may be multi-user, multiprocessing, multitasking, multithreading, real-time, and the like. The operating system may perform basic tasks, including but not limited to: recognizing input from input device(s) 504; sending output to display device(s) 506; keeping track of files and directories on computer-readable medium 512; controlling peripheral devices (e.g., disk drives, printers, etc.) which can be controlled directly or through an I/O controller; and managing traffic on bus 510. Network communications instructions 516 may establish and maintain network connections (e.g., software for implementing communication protocols, such as TCP/IP, HTTP, Ethernet, telephony, etc.).

Programming code 518 may include instructions that enable computing device 500 to determine whether a user has a self-control problem by analyzing transactions for the user. Upon determining that the user has a self-control program, computing device 500 may take proactive steps to notify the user of the self-control problem and provide the user with recommendations for overcoming the self-control problem. Application(s) 520 may be an application that uses or implements the processes described herein and/or other processes. The processes may also be implemented in operating system 514.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method performed by a computing system comprising:
receiving, from a plurality of institutions associated with a target user, a plurality of transactions associated with the target user;
grouping the plurality of transactions into a category or subcategory based on transaction data associated with each respective transaction;
determining, based on the plurality of transactions, that the target user has a self-control problem, the determining comprising:
identifying a plurality of payroll periods, each payroll period being associated with a paycheck;
for each payroll period, identifying a first subset of transactions that occur at a beginning of a respective payroll period and a second subset of transactions that occur at an end of the respective payroll period;
for each payroll period, filtering the first subset of transactions and the second subset of transactions to include discretionary expenses;
for each payroll period, summing the discretionary expenses in the first subset of transactions to generate a first sum;
for each payroll period, summing the discretionary expenses in the second subset of transactions to generate a second sum; and
applying a parametric test to the first sum and the second sum for each payroll period to determine whether the target user has the self-control problem; and
generating an alert or recommendation to the target user, upon determining that the target user has the self-control problem, notifying the target user of the self-control problem.

2. The method of claim 1, further comprising:
aggregating the plurality of transactions based on an account type associated with each transaction.

3. The method of claim 1, further comprising:
identifying a first plurality of users that do not have the self-control problem and a second plurality of users that have the self-control problem, the second plurality of users comprising the target user; and
clustering the first plurality of users and the second plurality of users into a plurality of clusters based on demographic information associated with each user of the first plurality of users and the second plurality of users.

4. The method of claim 3, wherein generating the alert or the recommendation to the target user comprises:
identifying a cluster of the plurality of clusters to which the target user is assigned;
learning financial characteristics of other users assigned to the cluster, the other users associated with the first plurality of users that do not have the self-control problem; and
recommending financial habits to the target user based on the financial characteristics of the other users.

5. The method of claim 1, wherein determining that the target user has the self-control problem further comprises:
assigning a self-control problem ranking to the target user based on a confidence level associated with determine that the target user has the self-control problem.

6. The method of claim 1, further comprising:
deriving additional financial metrics for the target user based on the plurality of transactions.

7. The method of claim 6, further comprising:
applying a regression algorithm to the target user and other users to identify the additional financial metrics that contribute the self-control problem.

8. A system comprising:
a processor; and
a memory having one or more instructions stored thereon, which, when executed by the processor, causes the system to perform operations comprising:
receiving, from a plurality of institutions associated with a target user, a plurality of transactions associated with the target user;
grouping the plurality of transactions into a category or subcategory based on transaction data associated with each respective transaction;
determining, based on the plurality of transactions, that the target user has a self-control problem, the determining comprising:
identifying a plurality of payroll periods, each payroll period being associated with a paycheck;
for each payroll period, identifying a first subset of transactions that occur at a beginning of a respective payroll period and a second subset of transactions that occur at an end of the respective payroll period;
for each payroll period, filtering the first subset of transactions and the second subset of transactions to include discretionary expenses;
for each payroll period, summing the discretionary expenses in the first subset of transactions to generate a first sum;
for each payroll period, summing the discretionary expenses in the second subset of transactions to generate a second sum; and
applying a parametric test to the first sum and the second sum for each payroll period to determine whether the target user has the self-control problem; and
generating an alert or recommendation to the target user, upon determining that the target user has the self-control problem, notifying the target user of the self-control problem.

9. The system of claim 8, wherein the operations further comprise:
aggregating the plurality of transactions based on an account type associated with each transaction.

10. The system of claim 8, wherein the operations further comprise:
identifying a first plurality of users that do not have the self-control problem and a second plurality of users that have the self-control problem, the second plurality of users comprising the target user; and
clustering the first plurality of users and the second plurality of users into a plurality of clusters based on demographic information associated with each user of the first plurality of users and the second plurality of users.

11. The system of claim 10, wherein generating the alert or the recommendation to the target user comprises:
identifying a cluster of the plurality of clusters to which the target user is assigned;
learning financial characteristics of other users assigned to the cluster, the other users associated with the first plurality of users that do not have the self-control problem; and
recommending financial habits to the target user based on the financial characteristics of the other users.

12. The system of claim 8, wherein determining that the target user has the self-control problem further comprises:
assigning a self-control problem ranking to the target user based on a confidence level associated with determine that the target user has the self-control problem.

13. The system of claim 8, wherein the operations further comprise:
deriving additional financial metrics for the target user based on the plurality of transactions.

14. The system of claim 13, wherein the operations further comprise:
applying a regression algorithm to the target user and other users to identify the additional financial metrics that contribute the self-control problem.

15. A non-transitory computer readable medium comprising a sequence of instructions, which, when executed by a processor, causes a computing system to perform operations comprising:
receiving, from a plurality of institutions associated with a target user, a plurality of transactions associated with the target user;
grouping the plurality of transactions into a category or subcategory based on transaction data associated with each respective transaction;
determining, based on the plurality of transactions, that the target user has a self-control problem, the determining comprising:
identifying a plurality of payroll periods, each payroll period being associated with a paycheck;
for each payroll period, identifying a first subset of transactions that occur at a beginning of a respective payroll period and a second subset of transactions that occur at an end of the respective payroll period;
for each payroll period, filtering the first subset of transactions and the second subset of transactions to include discretionary expenses;
for each payroll period, summing the discretionary expenses in the first subset of transactions to generate a first sum;
for each payroll period, summing the discretionary expenses in the second subset of transactions to generate a second sum; and
applying a parametric test to the first sum and the second sum for each payroll period to determine whether the target user has the self-control problem; and
generating an alert or recommendation to the target user, upon determining that the target user has the self-control problem, notifying the target user of the self-control problem.

16. The non-transitory computer readable medium of claim 15, further comprising:
aggregating the plurality of transactions based on an account type associated with each transaction.

17. The non-transitory computer readable medium of claim 15, further comprising:
identifying a first plurality of users that do not have the self-control problem and a second plurality of users that have the self-control problem, the second plurality of users comprising the target user; and
clustering the first plurality of users and the second plurality of users into a plurality of clusters based on demographic information associated with each user of the first plurality of users and the second plurality of users.

18. The non-transitory computer readable medium of claim 17, wherein generating the alert or the recommendation to the target user comprises:
identifying a cluster of the plurality of clusters to which the target user is assigned;
learning financial characteristics of other users assigned to the cluster, the other users associated with the first plurality of users that do not have the self-control problem; and
recommending financial habits to the target user based on the financial characteristics of the other users.

19. The non-transitory computer readable medium of claim 15, wherein determining that the target user has the self-control problem further comprises:
assigning a self-control problem ranking to the target user based on a confidence level associated with determine that the target user has the self-control problem.

20. The non-transitory computer readable medium of claim 15, further comprising:
deriving additional financial metrics for the target user based on the plurality of transactions; and
applying a regression algorithm to the target user and other users to identify the additional financial metrics that contribute the self-control problem.
